(19) United States
(12) Patent Application Publication
(10) Pub. No.: US 2026/0328050 A1
(43) Pub. Date: Oct. 22, 2026

(54) REVOLVING DOOR

(71) Applicant: dormakaba Deutschland GmbH, Ennepetal (DE)

(72) Inventors: Tim WULBRANDT, Ennepetal (DE); Daniel FABRI, Ennepetal (DE); Thomas IRRGANG, Ennepetal (DE); Bernhard HEITZ, Ennepetal (DE); Thomas UEBELGÜNNE, Ennepetal (DE)

(21) Appl. No.: 18/993,284

(22) PCT Filed: Jul. 7, 2023
(86) PCT No.: PCT/EP2023/068893

§ 371 Date: Jan. 10, 2025

(30) Foreign Application Priority Data
Jul. 11, 2022 (EP) 22184152.1
Jul. 11, 2022 (EP) 22184171.1
Jul. 11, 2022 (EP) 22184174.5

(51) Int. Cl. E06B 7/28; E06B 3/02; E06B 3/90

(52) U.S. Cl. CPC E06B 7/28; E06B 3/02; E06B 3/90

(57) ABSTRACT

The invention relates to a revolving door includes a turnstile that is arranged between opposite drum elements, and a ceiling assembly which is connected to the drum elements at the top and on which the turnstile is rotatably mounted. The turnstile has door leaf elements wherein at least one of the door leaf elements has a display for displaying information, on each of which door leaf elements at least one brush arrangement is formed, wherein electrical foil conductors are arranged on the door leaf elements, by means of which foil conductors the display is electrically contacted.

The invention relates to a revolving door having a turnstile that is arranged between opposite drum elements, and having a ceiling assembly which is connected to the drum elements at the top, in particular directly or indirectly, and on which the turnstile is rotatably mounted, with the turnstile having door leaf elements, with at least one of the door leaf elements having a display for displaying information.

Revolving doors are known from DE 101 22 526 B, DE 10 2004 029 762 A1 or WO 94/00661 A1 having a turnstile that is arranged between opposite drum elements, and the revolving doors are designed with a ceiling assembly which is connected to the drum elements at the top and on which the turnstile is rotatably mounted. The turnstile is made up of door leaf elements, on each of which at least one brush arrangement is formed. Brush arrangements of this type can be arranged both in the direction of the ceiling assembly, in the floor direction and in the direction of the inner sides of the drum elements on the door leaf elements, and in particular they wipe over the inner surface of the drum elements during a rotary movement of the turnstile. Door leaf elements are known with door leaf frames in which glass panes are enclosed, and the brush arrangements are provided on the outside of the frame of the door leaf elements. In addition, door leaf elements are known as all-glass door leaves, and the brushes can also be arranged on the edge of the all-glass door leaves via corresponding profile strips, with a profile structure then also being used to connect the brush arrangement to the all-glass door leaf, as a result of which the door leaf elements must advantageously be designed with further joints and edges and the profile structure is generally wider than the glass elements. The wider and therefore thicker profile structure also leads to additional edges and ridges, which further increase the risk of injury for people entering the revolving door.

The object of the invention is to improve the overall appearance and/or functionality of the revolving door.

This object is achieved on the basis of a revolving door according to the preamble of claim 1 with the characterising features. Advantageous further developments of the invention are indicated in the dependent claims.

The invention includes the technical teaching that electrical foil conductors are arranged on the door leaf elements, by means of which foil conductors the display, in particular LCD, is electrically contacted. This allows the appearance and/or functionality of the revolving door to be further improved. It also improves the integration of the display into the door leaf element.

It is also conceivable that at least one of the door leaf elements has a sensor and/or an illumination element. These can also be contacted in an electrical and/or data-transmitting manner by means of electrical foil conductors arranged on the door leaf element. These electrical foil conductors can also be arranged in a brush arrangement on a door leaf edge of the at least one door leaf element or on a centre column of the turnstile and preferably be contacted at a rotary feed-through. This provides additional functionality on the door leaves without visible connections.

It is conceivable to use the display to indicate a risk of being caught, injury or entrapment for the user, and preferably also to indicate actions to minimise the risk.

Preferably, the electrical foil conductors are arranged in a brush arrangement on a door leaf edge or on a centre column of the turnstile and make contact with a rotary feed-through. The rotary feed-through can be designed as a slip ring. This improves the integration of the display into the door leaf element.

The door leaf elements are preferably designed as all-glass door leaves. As already described, such all-glass door leaves are designed without a door leaf frame or frameless.

It is also conceivable that at least one of the drum elements has a display, in particular an LCD, for displaying information. This allows the appearance and/or functionality of the revolving door to be further improved. This display can also be contacted in an electrical and/or data-transmitting manner by means of electrical foil conductors arranged on the drum element. It is also conceivable that at least one of the drum elements has a sensor and/or an illumination element. These can also be contacted in an electrical and/or data-transmitting manner by means of electrical foil conductors arranged on the drum element.

It is also conceivable that at least one brush arrangement is formed on each of the door leaf elements. Preferably, the brush arrangement has a width that is adapted to the width of the door leaf elements. A uniform transition from the door leaf element into the brush arrangement and preferably ultimately into the bristles is advantageous such that the width of the brush arrangement corresponds to the thickness of the door leaf element. In particular, this results in an improvement of brush arrangements on the leaf elements of revolving doors. In particular, the brush arrangement can be further developed such that it merges into the door leaf elements with as few joints and edges as possible.

The brush arrangement can have a brush with a large number of bristles, but within the meaning of the invention the term brush arrangement also includes brushes made of a one-piece rubber body, of foam rubber, of felt strips, of a silicone lip or the like, such that the brush arrangement does not have to be a brush in the classical sense. The brush arrangement can therefore be designed in alternative materials and configurations.

The door leaf elements can be formed from at least one or two glass plates, with it also being conceivable that more than two glass plates, in particular with corresponding intermediate layers, are provided to form the door leaf elements. In particular, the door leaf elements can be formed of so-called laminated safety glass (LSG), which has a plurality of glass plates with at least one plastic layer or film in between.

According to one possible configuration, the brush arrangement has a holding strip and a brush strip arranged on the holding strip. The holding strip and/or the brush strip can each have a profile cross-section with a width that corresponds approximately or exactly to the width of the respective door leaf elements. The width corresponding approximately to the width of the door leaf elements includes deviations that are less than 10%, less than 5%, less than 2% and in particular less than 1%. Thus, the bristles of the brush arrangement can also fan out and protrude from the level of the door leaf elements, and they nevertheless form an embodiment variant of the invention.

Furthermore, the brush strip can have a base section with a width that corresponds to the width of the respective door leaf elements. In particular, the corresponding width can include a deviation of up to 5%, in particular 3% or 1% or 5 mm or 2 mm. The brush strip is preferably enclosed with the base section in the holding strip and can have bristles which consist of natural hair, synthetic hair, silicone, a foam rubber, one or a plurality of lips or the like, which have the width of the door leaf elements without force being applied and/or when new. When force is applied, for example when the brush strip slides along the inner side of the drum elements, the bristles of the brush strip can have an angle of inclination that is in particular less than 30°, in particular 20°, in particular 10° and preferably less than 8°. Consequently, the brush arrangement can also diverge from the level of the door leaf elements within the meaning of the invention, but the bristles of the brush strip extend in the plane level of the door leaf elements without force being applied or when new.

The door leaf elements have a door leaf edge, with a mounting strip being arranged on the door leaf edge, in particular for detachable attachment of the brush arrangement. In particular, the mounting strip can be connected to the door leaf edge in a materially-bonded manner, in particular adhered, and/or in a force-fitting and/or form-fitting manner. This avoids a profile that covers and encloses the sides of the glass elements. The brush arrangement can be attached to the mounting strip in a materially-bonded and/or force-fitting and/or form-fitting manner, for example it is possible to adhere, clamp or latch the brush arrangement to the mounting strip in a form-fitting manner, for example with a keyhole geometry or the like, into which mushroom head pins are engaged.

It is further advantageous that between the door leaf edge and the mounting strip and/or the holding strip is formed a cavity, in which electrical conductors in particular can be arranged. Thus, all-glass door leaf elements with the monolithic brush arrangement according to the invention can also be equipped with sensors and/or illumination elements that can be connected by way of the brush arrangement to electrical conductors that are not visible from the outside.

The respective door leaf edge to which the brush arrangement is attached can face the inner side of the drum elements, or the door leaf edge can face the floor or the ceiling assembly. Of course, a plurality of brush arrangements on one or a plurality of door leaf edges of the at least one door leaf element are conceivable. This allows the door leaf element to have a monolithic appearance on all sides.

The dimensions of the ceiling assembly are determined such that the drum elements form the outer finish of the revolving door and/or the ceiling assembly or part of the ceiling assembly does not protrude over the drum elements. With this further configuration of the drum elements, in particular with regard to the transition to the ceiling assembly, the advantage is achieved that the revolving door has side wall regions that are designed without joints or interruptions and thus offer a monolithic appearance and can also only accumulate dirt to a very small extent, as no dirt can accumulate in transitions, cracks, joints, radial projections or other transitions. The monolithic design is continued in the door leaf elements and the brush arrangements arranged thereon.

In particular, it is provided that the ceiling assembly is at least partially accommodated between the drum elements such that the drum elements enclose the ceiling assembly on the outside in an upper region and/or form an upper end edge on the revolving door. In this respect, a section at the structural height of the ceiling assembly can also form part of the side wall region, which merges into the drum elements at the bottom without any projections when viewed from an upper end edge. The end edge forms the upper circumferential border of the revolving door and can only be formed by the ceiling element, by the ceiling element in the transition to the drum element or only by the drum element.

This also makes it possible for the top cover plate of the ceiling assembly to radially protrude or cover the drum elements in the region of the upper end edge of the revolving door such that it protrudes up to the vertical outer surface of the drum elements.

In particular, the drum elements extend uninterrupted and continuously over a side wall region that is spanned vertically and circumferentially on the outside up to the upper end edge of the revolving door if the ceiling assembly is enclosed in the drum elements on the inside.

Particularly advantageously, the ceiling assembly has a sandwich structure with a bottom cover plate, a filler material and/or a top cover plate. The top cover plate with the drum elements can form the upper end edge of the revolving door.

The ceiling assembly can thus have a modular structure such that at least one filler material is provided as the core material, and the filler material has a cover plate on at least one or both cover surfaces. In this respect, only a top cover plate, only a bottom cover plate or a top and a bottom cover plate can be provided, which preferably run parallel to each other and between which the filler material is located. It is also conceivable that further cover plates are present, which penetrate the filler material and form an intermediate cover plate level, for example.

An intermediate level may be necessary, for example, to increase the rigidity of the ceiling assembly and to accommodate components within the ceiling assembly or to hold them in relation to each other or to stiffen them together in their overall structure. The basic idea, however, provides for a sandwich structure that enables a ceiling assembly which can be handled in a modular manner and which can be connected to the drum elements as a whole on-site, in particular can be placed on top of the drum elements, preferably with the turnstile accommodated in a rotatable manner between the drum elements. According to an additional and in particular preferred alternative variant, the bottom cover plate and/or the top cover plate can be connected to the filler material in a thermo-bonding process. After the ceiling assembly has been made up with the filler material and the cover plates and optionally also with other functional and structural elements, the sandwich formed in this way can be thermally pressed in an oven, i.e. literally baked, by applying a pressing force and heating to create the materially-bonded laminate, with the parallelism of the cover plates and the exact height of the ceiling assembly in particular being able to be calibrated at the same time.

For a further improved monolithic appearance of the revolving door, in particular in conjunction with the monolithic door leaf elements and the brush arrangements merging onto them without projections, a ceiling device can be arranged on the turnstile in a co-rotating manner, against which ceiling device the brush arrangements of the door leaf elements rest stationary at the top.

The ceiling device rotates with the rotation of the turnstile and is rigidly connected thereto such that the ceiling device forms a rotatable unit with the turnstile between the drum elements. The ceiling device is located adjoining the underside of the ceiling assembly, and in particular there may be a gap between the ceiling device and the ceiling assembly. The ceiling assembly can thus have an underside that is equipped with structural and functional elements without the ceiling assembly having to have cladding and meet visual requirements, as it is only the ceiling device that forms the region of the revolving door that is visible at the top from the access region. Particularly advantageously, the ceiling device and the ceiling assembly are designed to be plane-parallel to each other, with the ceiling device being able to extend in at least one or a plurality of planes; it is also conceivable that the ceiling assembly has regions that are at different distances from the ceiling device.

In particular, the ceiling device can completely cover the underside of the ceiling assembly, with the ceiling device preferably having a diameter that substantially matches the diameter of the ceiling assembly. The deviation of the diameter of the ceiling assembly from the diameter of the ceiling device can, for example, be less than 50%, preferably less than 20% and particularly preferably less than 5%; in particular, the ceiling device can have a diameter with which it substantially completely covers the ceiling assembly from the underside such that the underside of the ceiling assembly is no longer visible. In any case, the diameter of the ceiling device can be determined such that the ceiling assembly only remains visible from a side perspective.

The turnstile can have a plurality of door leaf elements, for example two, three or four door leaf elements, with the ceiling device having sections which are arranged between the door leaf elements at the upper end of the turnstile pointing towards the ceiling device. It is also possible to arrange the sections on the door leaf elements at the top, or the ceiling device is designed as a flat circular disc and is placed on the door leaf elements at the top, for example with a central opening to connect a centre column of the turnstile to a motor in the ceiling assembly. It is also possible for the ceiling device to be designed in two parts and in particular to comprise two semicircles.

The sections can be attached on or to the door leaf elements in a force-fitting and/or materially-bonded and/or form-fitting manner, and it can be provided that the sections form a stiffening structure for the door leaf elements and thus also for the turnstile as a whole. The number of sections can correspond to the number of door leaf elements of the turnstile.

It is therefore possible for the sections to be arranged on the door leaf elements to form a structure that aligns the door leaf elements with each other and/or a stiffening structure.

It is also conceivable that the display is arranged on the glass plate such that the display is enclosed by the transparent glass surface of the glass plate. This improves the integration of the display into the door leaf element.

It is also conceivable that at least one of the door leaf elements has at least two glass plates arranged parallel to one another, with the display being configured between the glass plates, preferably with the glass plates being connected to one another by means of a composite film, with the display being integrated in the composite film or arranged at or on the composite film. This enables optimum integration.

It is also conceivable that the display is designed for interaction with a person, in particular by means of touch input, preferably with the interaction enabling the rotational speed of the turnstile to be stopped and/or changed. In particular, an emergency stop of the rotation can thus be carried out by a user, a person inside the revolving door. This is in particular an improvement over conventional systems in which an emergency stop function is only possible from outside the revolving door. This means that the safety of users can be increased even in unforeseeable situations.

It is also conceivable that the drum elements each have an inner glass element and an outer glass element, with the ceiling assembly resting directly or indirectly on an upper end surface of the inner glass element and/or on an upper end surface of the outer glass element. It is conceivable that the inner glass element has a shorter vertical length than the outer glass element such that the outer glass element at least partially or completely encloses the ceiling assembly on the outside. In combination with the door leaf elements, this further improves the appearance of the revolving door. The user is given the impression of an edgeless system with a simultaneously high level of interaction.

Preferably, at least one profile element is provided which rests on the upper end surface of the inner glass element and/or the upper end surface of the outer glass element, with the ceiling assembly being accommodated in or on the profile element. The profile element can be adhered to the inner glass element and/or to the outer glass element. Preferably, at least one region of the outer glass element, which protrudes above the inner glass element in height, has a coating or is coloured. This further improves the appearance and functionality of the overall system.

### PREFERRED EXEMPLARY EMBODIMENT OF THE INVENTION

Further measures that improve the invention are described in more detail below together with the description of a preferred exemplary embodiment of the invention on the basis of the figures, in which is shown:

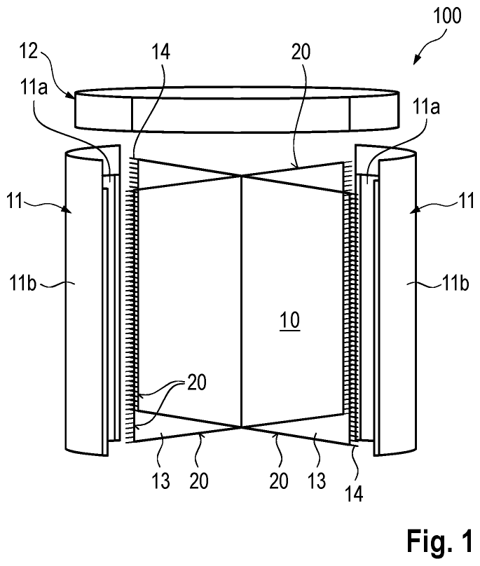

FIG. 1 a perspective view of the essential components of the revolving door and with door leaf elements to which brush arrangements are attached,

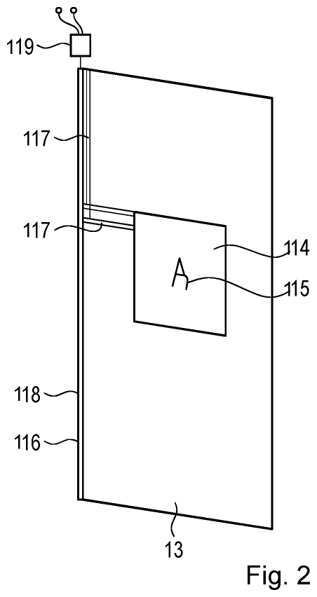

FIG. 2 the view of a door leaf element with a display attached thereto,

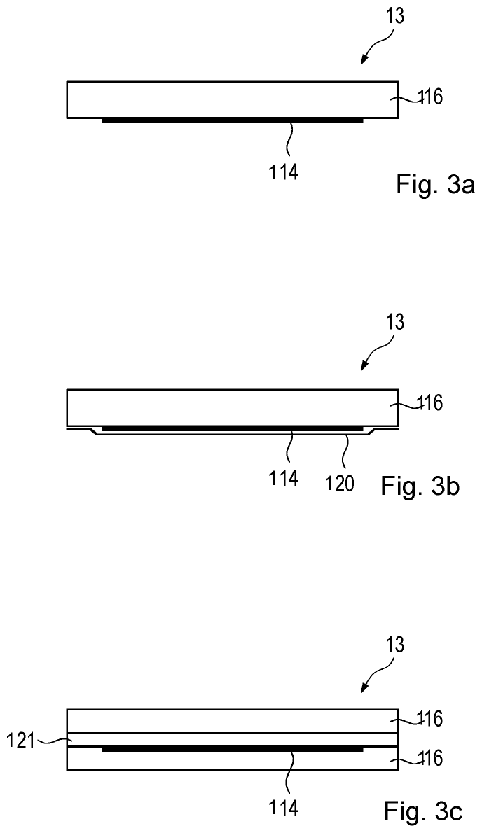

FIG. 3a/b/c each an exemplary embodiment of the arrangement of a display on a door leaf element,

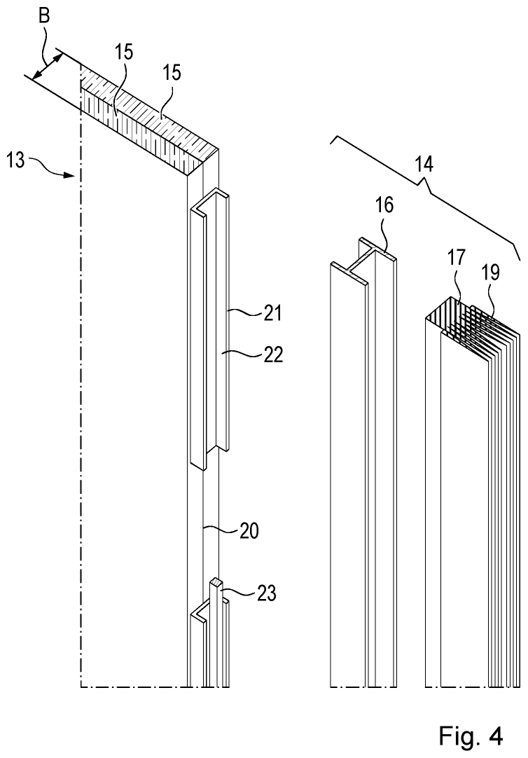

FIG. 4 an exploded representation of a brush arrangement at a distance from a door leaf element,

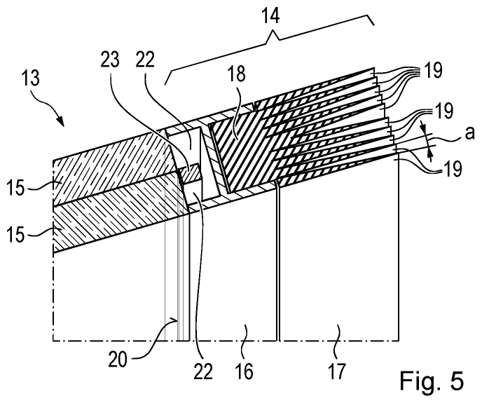

FIG. 5 a further detailed view of the brush arrangement on the door leaf element and

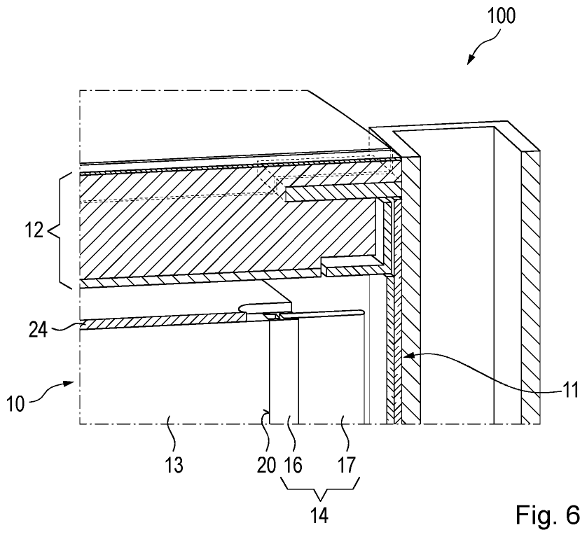

FIG. 6 a sectional view through the ceiling assembly with a door leaf element arranged underneath, having a brush arrangement.

FIG. 1 shows an overhead view of the components of the revolving door 100 with two drum elements 11 arranged opposite each other, which are designed to accommodate the ceiling assembly 12 at the top. For this purpose, the curved drum elements 11 have an inner glass element 11a and an outer glass element 11b, with the inner glass element 11a having a shorter vertical length than the outer glass element 11b such that the outer glass element 11b protrudes beyond the inner glass element 11a and at least partially or completely encloses the ceiling assembly 12 on the outside. To the door leaf edges 20 of the door leaf elements 13 of the turnstile 10 are attached brush arrangements 14, which point in the direction of the inner surface of the drum elements 11. In a manner not shown in detail, further brush arrangements 14 can also be arranged on the door leaf edges 20 of the door leaf elements 13 on the floor side or pointing in the direction of the ceiling assembly 12.

The door leaf elements 13 are designed as all-glass door leaves. Furthermore, one of the drum elements 11 has a display that is not represented. The display is contacted in an electrical and data-transmitting manner by means of foil conductors, which are also not represented. The revolving door is therefore transparent and interactive. Furthermore, one of the drum elements 11 can have an illumination system not represented and/or a sensor not represented, which are also contacted by means of foil conductors.

FIG. 2 shows an example of a door leaf element 13 arranged on a centre column 118 of a turnstile not represented further, and the display 114 for displaying the information 115 is located in the centre of the flat-shaped door leaf element 13. For electrical contacting of the display 114, the leaf element 13 has foil conductors 117, which are guided towards the centre column 118, for example, and are guided parallel thereto or in or on the centre column 118 to a rotary feed-through 119 in order to electrically connect the display 114 to a stationary part of the revolving door.

The foil conductors 117 are designed from such a thin layer that they are substantially transparent and therefore are not visible, but can still conduct electricity. In this way, the foil conductor 117, like the transparent display 114, can also be configured to not be visible such that the information 115 that can be shown with the display 114 appears to float in a certain way in the centre above the flat extension of the door leaf element 13.

The display can indicate a risk of getting caught, injury or entrapment for the user (not represented), and can also indicate actions to minimise the risk.

Furthermore, the door leaf element 13 has a sensor not represented and/or an illumination element. These can also be contacted in an electrical and/or data-transmitting manner by means of electrical foil conductors 117 arranged on the door leaf element or other foil conductors not represented here. These electrical foil conductors can also be arranged on the centre column 118 of the turnstile and be contacted at the rotary feed-through 119. This offers additional functionality on the door leaves without visible connections

FIG. 3a shows a cross-section through a door leaf element 13 having a glass plate 116, and the display 114 is applied to a surface of the glass plate 116 such that the glass plate 116, which forms the door leaf element 13, also forms the carrier substrate for the display 114.

FIG. 3b shows the door leaf element 13 having a glass plate 116 with a display 114, with the display 114 being covered with a protective body 120, for example having a protective film. The display 114 can form the actual electrically active LCD surface body, which is applied to the glass plate 116 as a carrier substrate, and the film-like protective body 120 covers the display 114, in particular also the remaining door leaf element 13.

FIG. 3c shows the door leaf element 13 with a first glass plate 116 and a second glass plate 116 arranged plane-parallel thereto, with a composite film 121 being inserted between the two glass plates 116. The display 114 is located between the composite film 121 and the lower glass plate 116 such that it is enclosed between the two glass plates 116. In this way, the door leaf element 13 can be constructed as laminated safety glass, and the display 114 is located in a protected manner between the two glass plates 116.

FIG. 4 shows a perspective view of the brush arrangement 14 at a distance from the door leaf element 13, resulting in an overhead view. The brush arrangement 14 has a holding strip 16 and a brush strip 17, and the bristles 19 are either arranged on the brush strip 17, for example pressed in, or formed in one piece with the brush strip 17.

The door leaf element 13 has two glass plates 15, which are connected to one another in a manner not shown in detail, for example via a film such that a laminated safety glass is used to form the door leaf element 13. However, in an embodiment not represented, the door leaf element 13 can be formed from a single glass plate 15, in particular as toughened safety glass. The other features apply analogously. The door leaf element 13 is designed with a width B and has, on the door leaf edge 20, a mounting strip 21, which is glued to the door leaf edge 20, for example. In the example shown, the mounting strip 21 is designed in a U-shape and its outer base surface is glued to the door leaf edge 20 such that a cavity 22 is created inside the U-shape when the holding strip 16 of the brush arrangement 14, which is formed with an H-profile, is arranged, for example clipped, on the mounting strip 21. For example, electrical conductors 23 can be routed in the cavity 22 along the door leaf edge 20 of the door leaf element 13, for which purpose cable holders can also be inserted in the cavity 22, for example arranged on the mounting strip.

Due to the H-profile of the holding strip 16, it has a cross-section by means of which the brush strip 17 can be inserted on a first side of the holding strip 16, and on an opposite side, the holding strip 16 forms the cavity 22 together with the mounting strip 21 when the holding strip 16 is arranged, for example, clipped, clamped or with a material bond on the mounting strip 21.

Both the holding strip 16 and the brush strip 17, in particular with the bristles 19, correspond to the width B of the door leaf element 13 such that in the assembled state of the brush arrangement 14 the door leaf elements 13 do not thicken at the edges and the entire brush arrangement 14 corresponds approximately to the width of the door leaf elements 13. The deviation of the width of the brush arrangement 14 relative to the width of the door leaf elements 13 can, for example, be up to a maximum of 30%, preferably up to a maximum of 20%, particularly preferably up to a maximum of 15% and most preferably up to a maximum of 10%, which the width dimension of the brush arrangement 14 exceeds the width B of the door leaf elements 13. When new and without the bristles 19 of the brush arrangement 14 being pressed on by contact with the inner side of the drum elements 11, the deviation can still be well below 10%, ideally 0%.

FIG. 5 shows a further view of the door leaf element 13, which is made up of two glass plates 15 connected to one another, with the brush arrangement 14 being arranged on the door leaf edge 20. Attaching the holding strip 16 creates the cavity 22, through which the electrical conductor 23 can be passed, for example. On the outer side of the holding strip 16, the brush strip 17 is enclosed via a base section 18, and the bristles 19 extend out of the base section 18 away from the door leaf element 13.

The bristles 19 can diverge at a slight angle a, for example less than 20%, preferably less than 10%, preferably less than 5% and most preferably less than 2% such that a slight deviation of the bristles 19 from the width B of the door leaf element 13 can occur in particular when the bristles 19 are in contact with the inner side of the drum elements.

FIG. 6 shows a further view of the door leaf element 13 below the ceiling assembly 12, and the brush arrangement 14 with the holding strip 16 and the brush strip 17 is arranged on the door leaf edge 20 of the door leaf element 13. The brush strip 17 is in contact with the inner side of the drum element 11 of the revolving door 100. A ceiling element 24 is arranged on the ceiling and the representation makes clear that the brush arrangement 14 extends up to the ceiling element 24 at the top. The ceiling element 24 rotates with the rotation of the door leaf elements 13 such that the brush arrangement 14 forms a clear geometric finish with the ceiling element 24, which geometric finish is orientated towards a minimum number of edges and ridges.

The design of the invention is not restricted to the preferred exemplary embodiment indicated above. In fact, a number of variants is conceivable which make use of the represented solution even in the case of fundamentally different designs. All features and/or advantages emerging from the claims, the description or the drawings, including constructive details or spatial arrangements, may be essential to the invention by themselves and in the most varied combinations.

### LIST OF REFERENCE NUMERALS

100 Revolving door
10 Turnstile
11 Drum element
12 Ceiling assembly

13 Door leaf element
14 Brush arrangement
15 Glass plate
16 Holding strip
17 Brush strip
18 Base section
19 Bristles
20 Door leaf edge
21 Mounting strip
22 Cavity
23 Electrical conductors
24 Ceiling element
B Width
a Angle
   116 Glass plate
   117 Foil conductor
   118 Centre column
   119 Rotary feed-through
   120 Protective body
   121 Composite film

1. A revolving door having a turnstile that is arranged between opposite drum elements, and having a ceiling assembly is connected to the drum elements at the top and on which the turnstile is rotatably mounted, wherein the turnstile has door leaf elements, wherein at least one of the door leaf elements has a display for displaying information,
wherein electrical foil conductors are arranged on the door leaf elements, by which foil conductors the display is electrically contacted.

2. The revolving door according to claim 1,
wherein in that the electrical foil conductors are arranged in a brush arrangement on a door leaf edge of the at least one door leaf element or on a centre column of the turnstile and are contacted at a rotary feed-through.

3. The revolving door according to claim 1, wherein
that the rotary feed-through is designed as a slip ring.

4. The revolving door according to claim 1, wherein
the door leaf elements are each formed from at least one or two or more parallel glass plates.

5. The revolving door according to claim 4,
wherein the display is arranged on the glass plate such that the display is enclosed by the transparent glass surface of the glass plate.

6. The revolving door according to claim 1, wherein
that at least one of the door leaf elements has at least two glass plates arranged parallel to one another, wherein the display is configured between the glass plates, wherein the glass plates are connected to one another by a composite film, wherein the display is integrated in the composite film or is arranged at or on the composite film,

7. The revolving door according to claim 1,
wherein
the display is designed for interaction with a person, touch input, wherein the interaction enables the rotational speed of the turnstile to be stopped and/or changed.

8. The revolving door according to claim 1,
wherein
the door leaf elements are designed as all-glass door leafs.

9. The revolving door according to claim 1,
wherein least one of the drum elements has a display for displaying information.
